(19) United States
(12) Patent Application Publication
(10) Pub. No.: US 2026/0036825 A1
(43) Pub. Date: Feb. 5, 2026

(54) AERIAL IMAGE DISPLAY SYSTEM, DISPLAY CONTROL DEVICE, DISPLAY CONTROL METHOD AND PROGRAM

(71) Applicant: NIPPON TELEGRAPH AND TELEPHONE CORPORATION, Tokyo (JP)

(72) Inventors: Motohiro MAKIGUCHI, Musashino-shi (JP); Ayaka SANO, Musashino-shi (JP); Takahiro MATSUMOTO, Musashino-shi (JP); Ryuji YAMAMOTO, Musashino-shi (JP)

(73) Assignee: NIPPON TELEGRAPH AND TELEPHONE CORPORATION, Tokyo (JP)

(21) Appl. No.: 19/099,481

(22) PCT Filed: Aug. 1, 2022
(86) PCT No.: PCT/JP2022/029440

§ 371 Date: Jan. 29, 2025

(51) Int. Cl. G02B 30/56; G02B 26/08

(52) U.S. Cl. CPC G02B 30/56; G02B 26/0816

(57) ABSTRACT

One aspect of the present invention is an aerial image display system including: a display device that displays a display image; and an optical system that includes a retroreflective member and an optical member having an optical characteristic of reflecting part of incident light and transmitting part of the incident light, and displays an aerial image corresponding to the display image toward a viewer, in which position information on the viewer is acquired, and an angle of a reflective surface of the retroreflective member is rotated by a designated angle from a direction of the viewer as a reference on the basis of the position information on the viewer acquired.

### TECHNICAL FIELD

One aspect of the present invention relates to, for example, an aerial image display system for displaying context information and the like in a space, and a display control device, a display control method, and a program used in the system.

### BACKGROUND ART

As a method of presenting context information and the like to a user, for example, an information presentation method using a mirror usually used by a person has been proposed. For example, Non Patent Literature 1 describes a method in which a special mirror is used having a function of transmitting part of incident light and reflecting part of the incident light, for example, a one-way mirror, and context information is transmitted through the mirror from a display arranged on a back side of the mirror and displayed in a front direction, whereby a virtual image of the user and a real image of the context information are simultaneously presented to the user.

In addition, Non Patent Literature 2 describes a method of performing information presentation with high reality by simultaneously displaying an aerial image of a front surface and an aerial image of a back surface respectively in a real space on the front side of a mirror and a mirror image space on the back side, for example, in the field of mixed reality (MR) that displays digital information in the real world.

### CITATION LIST

### Non Patent Literature

Non Patent Literature 1: Kaori Fujinami, Fahim Kawsar, Tatsuo Nakajima, “A Context-Aware Display System augmenting a Mirror”, Transactions of Information Processing Society of Japan, vol. 49 No. 6 p 1972-1983 (June 2008) Non Patent Literature 2: Hiroki Yamamoto, Hanyuool Kim, Naoya KOIZUMI, and Takeshi Naemura, “Horizontal and Vertical Mid-air Images Inside and Outside of a Mirror for Mixed Reality”, Three-Dimensional Image Conference, pp. 23-26, (July 2015)

### SUMMARY OF INVENTION

### Technical Problem

However, both of Non Patent Literature 1 and Non Patent Literature 2 fixedly present information in either the real space or the mirror image space. On the other hand, the digital information such as the context information originally does not matter the presentation space. Thus, there is a demand for development of an information presentation method with a higher degree of freedom without being bound by physical phenomena in the real world.

The present invention has been made in view of the above circumstances, and an object thereof is to provide a technology that enables presentation of an aerial image of digital information in any of a real space and a mirror image space, thereby increasing the degree of freedom in information presentation and improving visibility of the aerial image.

### Solution to Problem

In order to solve the above problems, one aspect of the present invention is an aerial image display system including: a display device that displays a display image; and an optical system that includes a retroreflective member and an optical member having an optical characteristic of reflecting part of incident light and transmitting part of the incident light, and displays an aerial image corresponding to the display image toward a viewer, in which position information on the viewer is acquired, and an angle of a reflective surface of the retroreflective member is rotated by a designated angle from a direction of the viewer as a reference on the basis of the position information on the viewer acquired.

In addition, position information on the display device may be acquired, and a position of the retroreflective member with respect to the viewer may be controlled together with the angle of the reflective surface of the retroreflective member on the basis of the position information on the viewer and the position information on the display device.

According to one aspect of the present invention, at least the angle of the reflective surface of the retroreflective member is controlled according to the position information of the viewer, whereby the retroreflective member is set not to face the viewer. Therefore, it is possible to prevent a virtual image of the display device from entering a viewing area of the viewer who is visually recognizing the aerial image, whereby the visibility of the aerial image by the viewer can be improved.

### Advantageous Effects of Invention

According to one aspect of the present invention, it is possible to provide a technology that enables presentation of an aerial image of digital information in any of a real space and a mirror image space, thereby increasing the degree of freedom in information presentation and improving visibility of the aerial image.

### BRIEF DESCRIPTION OF DRAWINGS

FIG. 1 is a diagram illustrating a first example of an optical system in an aerial image display system according to a first embodiment of the present invention.

FIG. 2 is a perspective view illustrating an example of a configuration of a display device provided in the aerial image display system illustrated in FIG. 1.

FIG. 3 is a diagram illustrating an operation example when an aerial image is formed in a real space in the aerial image display system illustrated in FIG. 1.

FIG. 4 is a diagram illustrating an operation example when an aerial image is formed in a mirror image space in the aerial image display system illustrated in FIG. 1.

FIG. 5 is a diagram illustrating an operation example when a direct view aerial image is presented in the aerial image display system illustrated in FIG. 1.

FIG. 6 is a diagram illustrating a second example of the optical system in the aerial image display system according to the first embodiment of the present invention.

FIG. 7 is a diagram illustrating a third example of the optical system in the aerial image display system according to the first embodiment of the present invention.

FIG. 8 is a cross-sectional view illustrating an example of a structure of a beam splitter used in the aerial image display system illustrated in FIG. 7.

FIG. 9 is a diagram illustrating a fourth example of the optical system in the aerial image display system according to the first embodiment of the present invention.

FIG. 10 is a diagram illustrating a fifth example of the optical system in the aerial image display system according to the first embodiment of the present invention.

FIG. 11 is a block diagram illustrating an example of a functional configuration of a display control device provided in an aerial image display system according to a second embodiment of the present invention.

FIG. 12 is a flowchart illustrating an example of a processing procedure and processing content of display control processing executed by a control unit of the display control device illustrated in FIG. 11.

FIG. 13 is a diagram for describing an example of a method of calculating an image parameter in the display control processing illustrated in FIG. 12.

FIG. 14 is a diagram for describing another example of calculating the image parameter in the display control processing illustrated in FIG. 12.

FIG. 15 is a diagram for describing an outline of an aerial image display system according to a third embodiment of the present invention.

FIG. 16 is a diagram illustrating an example of a configuration of an optical system of the aerial image display system according to the third embodiment of the present invention.

FIG. 17 is a block diagram illustrating an example of a functional configuration of a display control device provided in the aerial image display system according to the third embodiment of the present invention.

FIG. 18 is a flowchart illustrating an example of a processing procedure and processing content of display control processing executed by a control unit of the display control device illustrated in FIG. 17.

FIG. 19 is a flowchart illustrating an example of a processing procedure and processing content of rotation angle calculation processing in the display control processing illustrated in FIG. 18.

FIG. 20 is a diagram illustrating a first example of the rotation angle calculation processing illustrated in FIG. 19.

FIG. 21 is a diagram for describing a second example of the rotation angle calculation processing illustrated in FIG. 19.

FIG. 22 is a diagram for describing an outline of an aerial image display system according to a fourth embodiment of the present invention.

FIG. 23 is a diagram for describing the outline of the aerial image display system according to the fourth embodiment of the present invention.

FIG. 24 is a diagram illustrating an example of a configuration of an optical system of the aerial image display system according to the fourth embodiment of the present invention.

FIG. 25 is a block diagram illustrating an example of a functional configuration of a display control device provided in the aerial image display system according to the fourth embodiment of the present invention.

FIG. 26 is a flowchart illustrating an example of a processing procedure and processing content of display control processing executed by a control unit of the display control device illustrated in FIG. 25.

FIG. 27 is a diagram for describing an example of processing of calculating a position of a retroreflective member with respect to a display device in the display control processing illustrated in FIG. 26.

FIG. 28 is a diagram for describing an example of processing of calculating an angle of the retroreflective member in the display control processing illustrated in FIG. 27.

FIG. 29 is a diagram for describing the example of the processing of calculating the angle of the retroreflective member in the display control processing illustrated in FIG. 27.

FIG. 30 is a diagram illustrating a first example of an optical system in an aerial image display system according to a fifth embodiment of the present invention.

FIG. 31 is a diagram illustrating an example of an aerial image and a background image displayed by the aerial image display system illustrated in FIG. 30.

FIG. 32 is a diagram illustrating a second example of the optical system in the aerial image display system according to the fifth embodiment of the present invention.

FIG. 33 is a diagram illustrating a third example of the optical system in the aerial image display system according to the fifth embodiment of the present invention.

### DESCRIPTION OF EMBODIMENTS

In the following, embodiments according to the present invention will be described with reference to the drawings.

### First Embodiment

### First Example

### (Configuration Example)

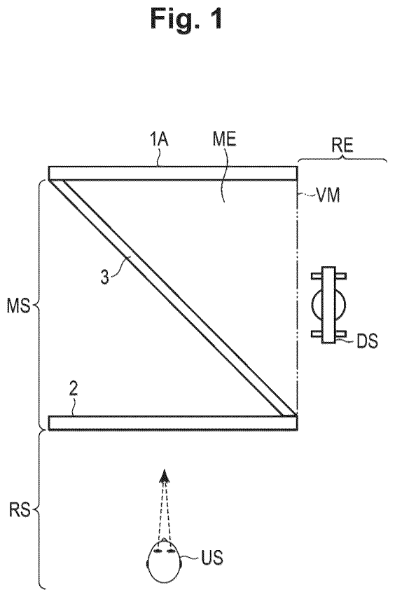

FIG. 1 is a diagram illustrating a first example of an aerial image display system according to a first embodiment of the present invention.

### (1) Optical System

In FIG. 1, a retroreflective member 1A is a retroreflective member, and the retroreflective member 1A is arranged such that a reflective surface is orthogonal to a viewing direction of a viewer (hereinafter also referred to as a user) US. In addition, a first beam splitter 2 is arranged between the user US and the retroreflective member 1A such that an action surface of the first beam splitter 2 is orthogonal to the viewing direction of the user US, that is, parallel to the reflective surface of the retroreflective member 1A. Further, a second beam splitter 3 is arranged in a space between the retroreflective member 1A and the first beam splitter 2. The second beam splitter 3 is arranged obliquely with an action surface having a predetermined angle, for example, an angle of 45° with respect to the viewing direction of the user US.

Both the first and second beam splitters 2 and 3 have an optical characteristic of transmitting part of incident light and reflecting part of the incident light. As a result, a real space RS is formed on the user US side from the first beam splitter 2, and a mirror image space MS is formed between the first beam splitter 2 and the retroreflective member 1A.

Further, a mirror image space movement region ME is formed in a triangular region between the retroreflective member 1A and the second beam splitter 3 in the mirror image space MS. In addition, a real space movement region RE is formed in a region adjacent to the mirror image space movement region ME on extension of each of surfaces of the retroreflective member 1A and the first beam splitter 2. A boundary between the mirror image space movement region ME and the real space movement region RE is a virtual mirror surface VM.

### (2) Display Device DS

A display device DS is arranged to be movable in the mirror image space movement region ME and the real space movement region RE.

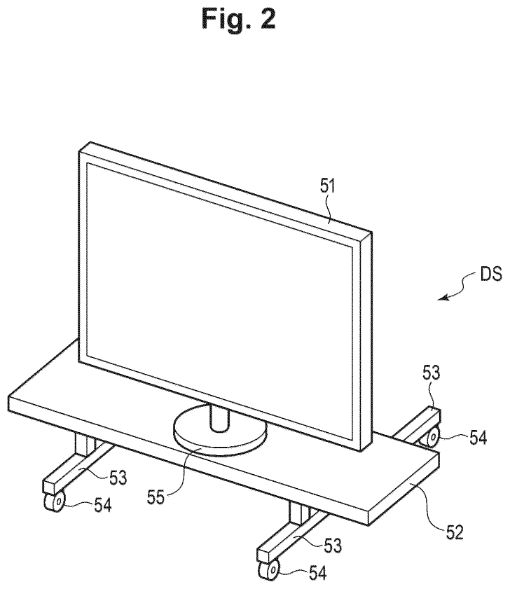

FIG. 2 is a perspective view illustrating an example of a configuration of the display device DS. In the display device DS, for example, a display device main body 51 including a liquid crystal panel, an organic EL panel, or an LED panel is placed on a base 52, and a lower surface portion of the display device main body 51 is provided with a leg portion 53 including a caster 54 in order to movably support the display device main body 51. In addition, a rotation mechanism unit 55 is installed on the upper surface of the base 52. The rotation mechanism unit 55 is used to variably set a display direction of the display device main body 51 in a range of a predetermined angle, for example, a range of 180°.

### (Operation Example)

With the above configuration, the aerial image display system operates as follows.

### (1) Case of Forming Aerial Image in Real Space RS

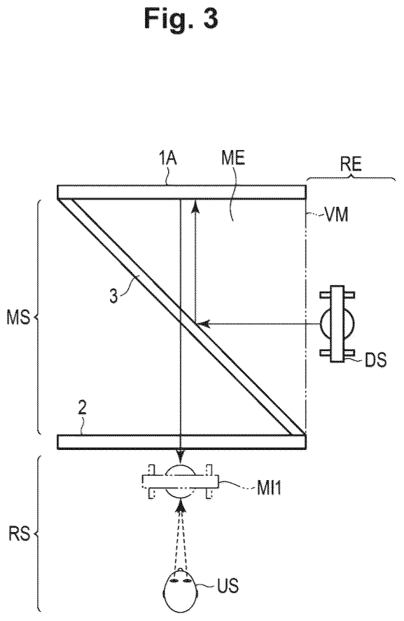

FIG. 3 is a diagram for describing operation in this case.

The display device DS is arranged in the real space movement region RE, and further, the display direction is set to be, for example, a direction orthogonal to the viewing direction of the user US. Note that setting of a position of the display device DS and setting of the display direction may be manually performed by an administrator or the viewer, or may be automatically performed by a display control device in illustration.

When the display position and the display direction of the display device DS are set in this manner, display information displayed on a display screen of the display device DS is reflected by the second beam splitter 3, then retroreflected by the retroreflective member 1A, sequentially transmitted through the second beam splitter 3 and the first beam splitter 2, and formed as an aerial image MIL in the real space RS where the user US is present.

Thus, the user US can visually recognize, for example, a figure, a photograph, or the like as an aerial image in the real space RS where the user US is present.

### (2) Case of Forming Aerial Image in Mirror Image Space MS

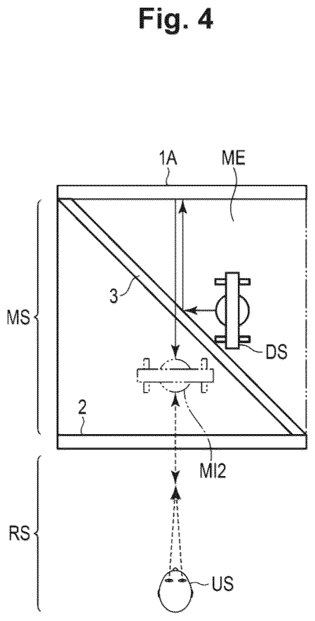

FIG. 4 is a diagram for describing operation in this case.

The display device DS is moved from the real space movement region RE to the mirror image space movement region ME. In addition, the display direction is set to be a direction orthogonal to the viewing direction of the user US. When the display position and the display direction of the display device DS are set in this manner, the display information displayed on the display screen of the display device DS is reflected by the second beam splitter 3, then retroreflected by the retroreflective member 1A, transmitted through the second beam splitter 3, and formed as an aerial image MI2 in the mirror image space MS.

Thus, with the first beam splitter 2 as a mirror, the user US can confirm news information such as traffic information and weather forecast by the aerial image MI2 formed in the mirror image space MS while performing work of, for example, brushing teeth, makeup, and straightening one′ appearance.

### (3) Case of Presenting Direct View Aerial Image to User US

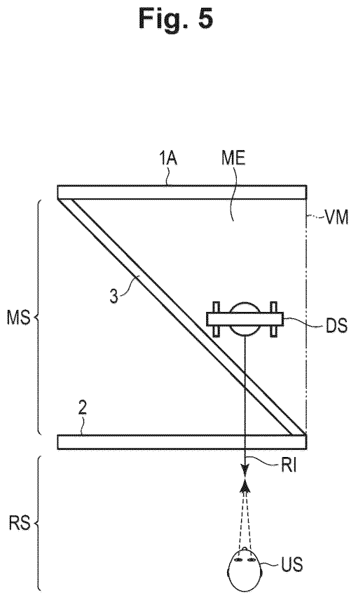

FIG. 5 is a diagram for describing operation in this case.

The display device DS is moved from the real space movement region RE to the mirror image space movement region ME. In addition, the display direction is set to a direction facing the viewing direction of the user US. When the display position and the display direction of the display device DS are set in this manner, the display information displayed on the display screen of the display device DS is sequentially transmitted through the second beam splitter 3 and the first beam splitter 2, and presented as a direct view aerial image RI to the user US in the real space RS.

Thus, the user US can view the display information in the real space RS as if looking directly at the display screen of the display device DS.

### Second Example

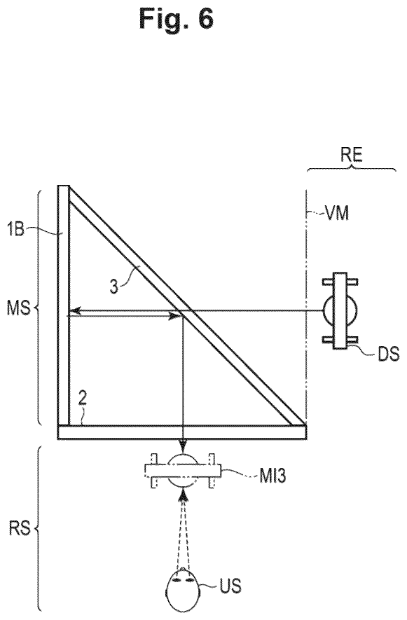

FIG. 6 is a diagram illustrating a second example of the aerial image display system according to the first embodiment of the present invention. Note that, in the figure, the same portions as those in FIG. 1 are denoted by the same reference signs, and detailed description thereof will be omitted.

In the second example, a retroreflective member 1B is arranged at a position on an opposite side from the virtual mirror surface VM with respect to the second beam splitter 3 of the mirror image space MS such that the reflective surface is in a direction parallel to the viewing direction of the user US.

With such a configuration, when the display device DS is arranged, for example, in the real space movement region RE and the display direction is set to a direction orthogonal to the viewing direction of the user US, the display information displayed on the display device DS is transmitted through the second beam splitter 3, then retroreflected by the retroreflective member 1B, reflected by the second beam splitter 3, then transmitted through the first beam splitter 2, and formed as an aerial image MI3 in the real space RS where the user US is present.

In addition, when the display device DS is arranged in the mirror image space movement region ME and the display direction is set to be in a direction orthogonal to the viewing direction of the user US, the display information displayed on the display screen of the display device DS is transmitted through the second beam splitter 3, then retroreflected by the retroreflective member 1B, and formed as the aerial image MI2 in the mirror image space MS.

Further, when the display device DS is arranged in the mirror image space movement region ME and the display direction is set to the direction facing the viewing direction of the user US, the display information displayed on the display device DS is sequentially transmitted through the second beam splitter 3 and the first beam splitter 2, and presented to the user US as the direct view aerial image RI in the real space RS.

Thus, also in the second example, an effect equivalent to that of the first example can be obtained.

### Third Example

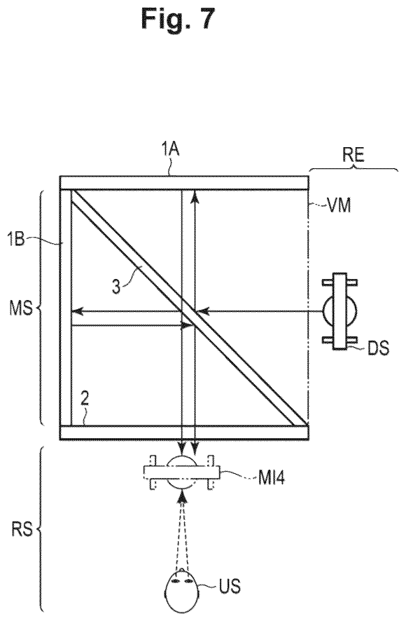

FIG. 7 is a diagram illustrating a third example of the aerial image display system according to the first embodiment of the present invention. Note that, in the figure, the same portions as those in FIGS. 1 and 6 are denoted by the same reference signs, and detailed description thereof will be omitted.

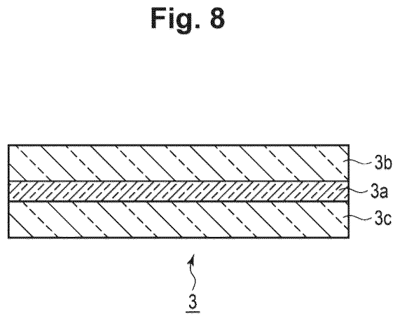

In the third example, the retroreflective member 1A and the retroreflective member 1B are arranged on two sides orthogonal to each other in the mirror image space MS such that the respective reflective surfaces are orthogonal to each other. In addition, as the second beam splitter 3, for example, as illustrated in FIG. 8, a beam splitter is used in which both surfaces of a reflective member 3a such as a semitransparent mirror having transmittance and reflectance set equal to each other are sandwiched between transparent members 3b and 3c such as two acrylic plates having the same thickness and refractive index.

With such a configuration, when the display device DS is arranged, for example, in the real space movement region RE and the display direction is set to a direction orthogonal to the viewing direction of the user US, the display information displayed on the display device DS is reflected by the second beam splitter 3, then retroreflected by the retroreflective member 1A, sequentially transmitted through the second beam splitter 3 and the first beam splitter 2, and formed as an aerial image in the real space RS where the user US is present. In addition, at the same time, the display information is transmitted through the second beam splitter 3, then retroreflected by the retroreflective member 1B, reflected by the second beam splitter 3, then transmitted through the first beam splitter 2, and formed as an aerial image in the real space RS where the user US is present. Note that the same applies to a case where an aerial image is formed in the mirror image space MS.

That is, in the real space RS and the mirror image space MS, a combined aerial image MI4 is formed in which the aerial image retroreflected by the retroreflective member 1A and the aerial image retroreflected by the retroreflective member 1B are combined.

Thus, according to the third example, it is possible to present the formed aerial image MI4 having high luminance as compared with a case where the retroreflective member 1A or 1B is used alone. In addition, since the second beam splitter 3 has a structure in which both surfaces of the reflective member 3a are sandwiched between the two transparent members 3b and 3c having the same thickness and refractive index as illustrated in FIG. 8, it is possible to set optical path lengths respectively corresponding to the first and second beam splitters 2 and 3 to be equal to each other, whereby it is possible to prevent double imaging of the formed aerial image MI4.

### Fourth Example

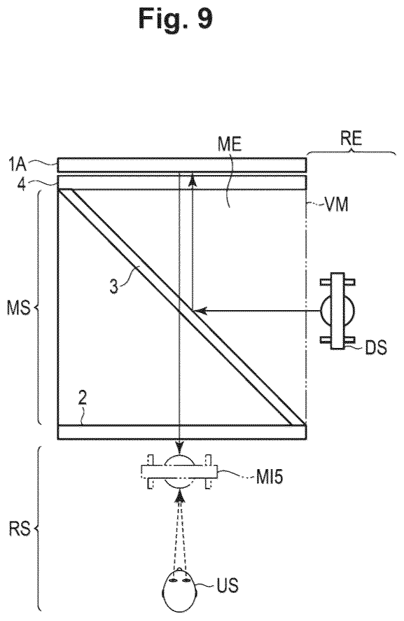

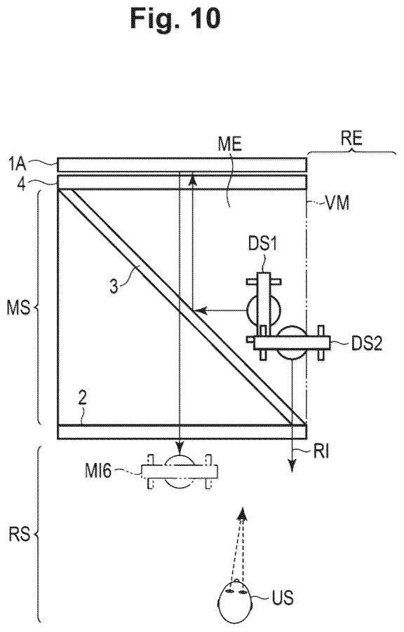

FIGS. 9 and 10 are diagrams illustrating a fourth example of the aerial image display system according to the first embodiment of the present invention.

In the fourth example, a retardation film 4 is arranged on the reflective surface of the retroreflective member 1A. The retardation film 4 includes, for example, a ¼ retardation film, and has an optical characteristic of rotating a polarization direction of transmitted light by 45 degrees. Further, as the first and second beam splitters 2 and 3, an optical element is used in which reflection and transmission switch depending on the polarization direction of the incident light. As the optical element, for example, a reflective polarizing plate or a wire grid is used. Note that, in the following description, as an example, a description will be given of operation in a case where installation is performed in a direction in which s-polarized light is reflected and P-polarized light is transmitted.

On the other hand, a depolarizing film, a diffusion plate, or a retardation film is attached to the display screen of the display device DS so that output light of the display information includes unpolarized light, or S-polarized light and P-polarized light. Alternatively, a polarizing plate or the retardation film is rotatably arranged in a state of facing the display screen of the display device DS, and switching of polarization directions of the output light is implemented by rotation.

With such a configuration, first, in a case where an aerial image is formed in the real space RS, the display device DS is arranged in the real space movement region RE in a state where the display direction is oriented in a direction orthogonal to the viewing direction. In addition, at the same time, in a case where a polarizing plate is arranged on the display screen of the display device DS, setting is performed by rotating the polarizing plate so that a polarization component to be reflected by the second beam splitter 3, for example, S-polarized light is output from the display device DS.

With this setting, for example, as illustrated in FIG. 9, the S-polarized light of display light output from the display device DS is reflected by the second beam splitter 3 and transmitted through the retardation film 4 arranged in front of the retroreflective member 1A to be converted into circularly polarized light. The circularly polarized light is retroreflected by the retroreflective member 1A to reverse a rotation direction, and is transmitted through the retardation film 4 again to be converted into P-polarized light. The retroreflected P-polarized light is transmitted through the second beam splitter 3, further transmitted through the first beam splitter 2, and formed as an aerial image MI5 in the real space RS.

Next, in a case where an aerial image is formed in the mirror image space MS, the display device DS is arranged in the mirror image space movement region ME in a state where the display direction is oriented in a direction orthogonal to the viewing direction. In addition, at the same time, setting is performed by rotating the polarizing plate arranged on the display screen of the display device DS so that S-polarized light is output from the display device DS.

With this setting, for example, as illustrated in FIG. 10, the S-polarized light of display light output from a display device DS1 is reflected by the second beam splitter 3, and retroreflected as P-polarized light by the retardation film 4 arranged in front of the retroreflective member 1A and the retroreflective member 1A similarly to the above. Then, the retroreflected P-polarized light is transmitted through the second beam splitter 3 and formed as an aerial image MI6 in the mirror image space MS.

In addition, in a case where the display information of the display device DS is presented as the direct view aerial image RI, the display direction is oriented to the direction of the user US in a state where the display device DS is arranged with the display direction in the mirror image space movement region ME. In addition, at the same time, setting is performed by rotating the polarizing plate/retardation plate arranged on the display screen of the display device DS so that P-polarized light is output from the display device DS.

With this setting, the p-polarized light of the display light output from the display device DS is sequentially transmitted through the second beam splitter 3 and the first beam splitter 2, and presented as the direct view aerial image RI to the user US present in the real space RS.

Thus, according to the fourth example, by selectively switching the display light output from the display device DS between the S-polarized light and the P-polarized light, it is possible to present an aerial image with high luminance while suppressing attenuation of light by a beam splitter on an optical path.

### Fifth Example

For example, as illustrated in FIG. 10, setting may be performed in which the display device DS1 and a display device DS2 are arranged in an L shape, and S-polarized light and P-polarized light are respectively output.

With this configuration, it is possible to simultaneously present a plurality of aerial images with high luminance in the mirror image space MS and the real space RS.

### Second Embodiment

### (Outline)

In the system described in the first embodiment, it is possible to display the aerial image seamlessly crossing the boundary between the mirror image space MS and the real space RS, whereby a practically extremely useful effect is exerted that the display of the aerial image can be diversified. However, since a formed aerial image MI undergoes a lot of reflection and transmission by the beam splitters 2 and 3 and the retroreflective members 1A and 1B on an optical path until the image is formed, contrast or the like decreases and image quality becomes uneven between the formed aerial image MI and the direct view aerial image RI.

Thus, in a second embodiment, when the formed aerial image MI is displayed, an image parameter of a display image on the display device DS is adjusted in advance, whereby the image quality is homogenized between the formed aerial image MI and the direct view aerial image RI.

### (Configuration Example)

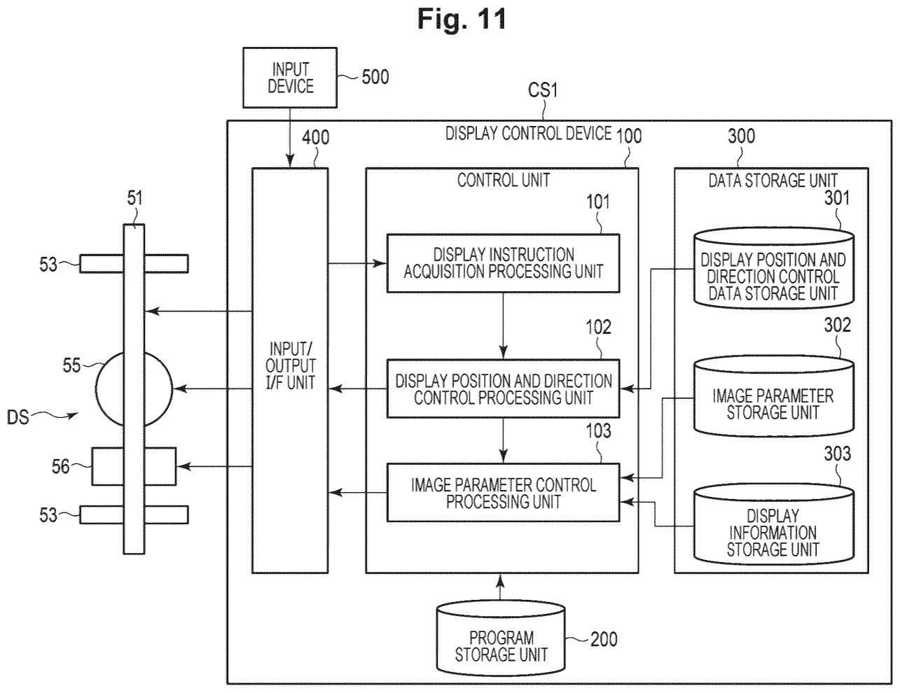

FIG. 11 is a block diagram illustrating a functional configuration of a display control device CS1 provided in an aerial image display system according to the second embodiment of the present invention together with the display device DS.

The display device DS is provided with a movement mechanism unit 56 for moving the display position and the rotation mechanism unit 55 for changing the display direction. Both of these mechanism units 56 and 55 operate according to a control signal output from the display control device CS1.

The display control device CS1 includes, for example, a personal computer, and includes a control unit 100 that uses a hardware processor such as a central processing unit (CPU). Then, a storage unit including a program storage unit 200 and a data storage unit 300, and an input/output interface (hereinafter, interface is referred to as I/F) unit 400 are connected to the control unit 100 via a bus (not illustrated).

An input device 500, for example, a keyboard, a mouse, or the like, is connected to the input/output I/F unit 400. Note that, in addition, a display device, an external storage medium such as a universal serial bus (USB) memory, or the like may be connected to the input/output I/F unit 400. In addition, the input/output I/F unit 400 may have a communication interface function.

The program storage unit 200 includes, as a storage medium, for example, a combination of a nonvolatile memory that enables writing and reading as needed, such as a solid state drive (SSD), and a nonvolatile memory such as a read only memory (ROM), and stores application programs necessary for control according to the second embodiment, in addition to middleware such as an operating system (OS). Hereinafter, the OS and the application programs will be collectively referred to as programs.

The data storage unit 300 is, for example, a combination of a nonvolatile memory that enables writing and reading as needed, such as an SSD, and a volatile memory such as a random access memory (RAM), as a storage medium, and in a storage area thereof, a display position and direction control data storage unit 301, an image parameter storage unit 302, and a display information storage unit 303 are prepared as main storage units necessary for implementing the second embodiment of the present invention.

The display position and direction control data storage unit 301 stores control data necessary for controlling the display position and the display direction of the display device DS according to an input display instruction. The image parameter storage unit 302 stores control data necessary for controlling the image parameter of the display information according to a type of the aerial image to be displayed. The display information storage unit 303 is used to store information to be displayed, for example, content information.

The control unit 100 includes a display instruction acquisition processing unit 101, a display position and direction control processing unit 102, and an image parameter control processing unit 103, as processing functions necessary for implementing the second embodiment of the present invention. The processing units 101 to 103 are implemented by causing a hardware processor of the control unit 100 to execute application programs stored in the program storage unit 200.

Note that some or all of the processing units 101 to 103 may be implemented by using hardware such as a large scale integration (LSI) or an application specific integrated circuit (ASIC).

In a case where display instruction information on the aerial image is input in the input device 500, the display instruction acquisition processing unit 101 acquires the display instruction information. The display instruction information gives an instruction of any of displaying a formed aerial image in the real space RS, displaying a formed aerial image in the mirror image space MS, or displaying a direct view aerial image in the real space RS.

The display position and direction control processing unit 102 reads control data from the display position and direction control data storage unit 301 according to instruction content of the display instruction information. Then, according to the read control data, a position control signal and a direction control signal are output from the input/output I/F unit 400 to the movement mechanism unit 56 and the rotation mechanism unit 55 of the display device DS, respectively, to set the display position and the display direction of the display device DS.

The image parameter control processing unit 103 determines whether the aerial image to be presented is the “formed aerial image” or the “direct view aerial image” according to setting data of the display position and the display direction of the display device DS. Then, the image parameter control processing unit 103 controls the image parameter of the display image to be displayed on the display device DS on the basis of a result of the determination and the image parameter stored in the image parameter storage unit 302. An example of control processing for the image parameter will be described in an operation example.

### (Operation Example)

Next, operation of the display control device CS1 configured as described above will be described.

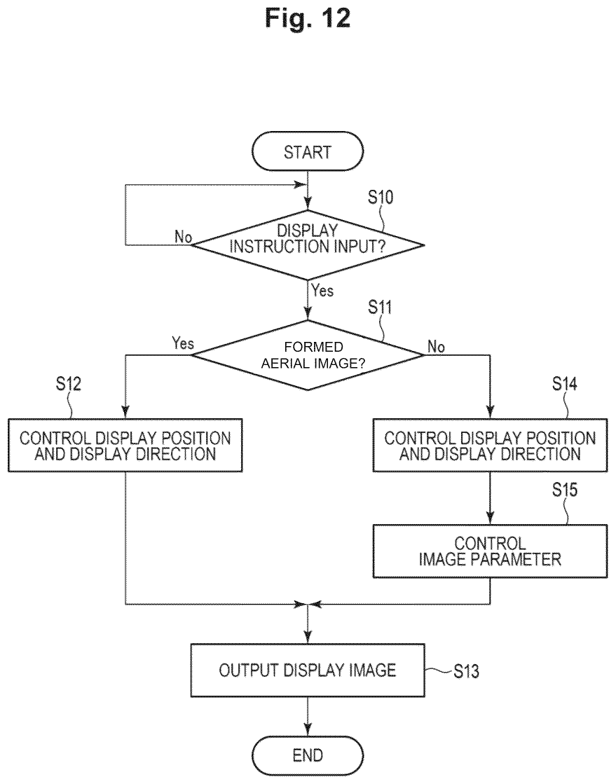

FIG. 12 is a flowchart illustrating an example of a processing procedure and processing content of display control processing executed by the control unit 100 of the display control device CS1.

The control unit 100 of the display control device CS1 monitors input of the display instruction information in step S10 under control of the display instruction acquisition processing unit 101. In this state, when the display instruction information is input in the input device 500, the control unit 100 of the display control device CS1 determines in step S11 whether the display instruction information is a display instruction for the “formed aerial image” or a display instruction for the “direct view aerial image” under control of the display position and direction control processing unit 102.

As a result of the above determination, if the display instruction is for the “formed aerial image”, the display position and direction control processing unit 102 proceeds to step S12, and generates a display position control signal on the basis of display position and direction control data stored in the display position and direction control data storage unit 301. Then, the display position and direction control processing unit 102 outputs the generated display position control signal to the movement mechanism unit 56 of the display device DS, whereby the display position of the display device DS is moved to the real space movement region RE or the mirror image space movement region ME.

In addition, the display position and direction control processing unit 102 generates a display direction control signal on the basis of the display position and direction control data. Then, the generated display direction control signal is output to the rotation mechanism unit 55 of the display device DS, whereby the display direction of the display device DS is set to a direction orthogonal to the viewing direction.

On the other hand, as a result of the determination, if the display instruction is for the “direct view aerial image”, the display position and direction control processing unit 102 proceeds to step S14, and generates a display position control signal on the basis of position and direction control data stored in the display position and direction control data storage unit 301. Then, the display position and direction control processing unit 102 outputs the generated display position control signal to the movement mechanism unit 56 of the display device DS, whereby the display position of the display device DS is moved to the mirror image space movement region ME.

In addition, at the same time, the display position and direction control processing unit 102 generates a display direction control signal on the basis of the position and direction control data. Then, the generated display direction control signal is output to the rotation mechanism unit 55 of the display device DS, whereby the display direction of the display device DS is set to a direction of the user US.

Note that, in the above description, whether to display the “formed aerial image” or the “direct view aerial image” is designated by the display instruction information. However, for example, in a case where content included in the display information includes information designating a type of the aerial image to be displayed, that is, whether it is the “formed aerial image” or the “direct view aerial image”, or information that enables determination of the type, the information may be used.

When control of setting the display position and the display direction of the display device DS ends, the control unit 100 of the display control device CS1 subsequently executes processing of controlling the image parameter of the display information as follows under control of the image parameter control processing unit 103.

That is, the image parameter control processing unit 103 receives the display instruction (“formed aerial image” or “direct view aerial image”) from the display position and direction control processing unit 102, and sets the image parameter corresponding to the received display instruction.

Here, as the image parameter, control data of the image parameter is used stored in advance in the image parameter storage unit 302. As a method of calculating the control data of the image parameter, following two methods are conceivable. Here, contrast (blur strength) is taken as an example of the image parameter to be controlled.

### (1) First Calculation Method

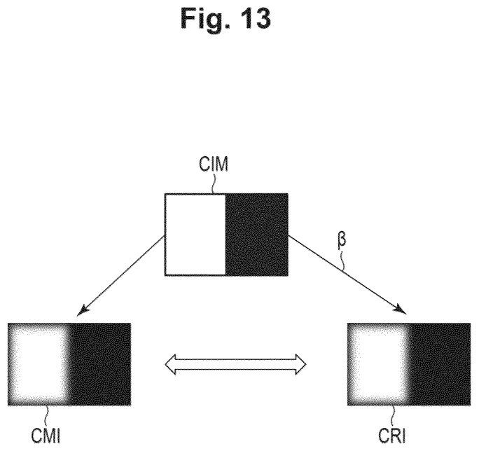

FIG. 13 is a diagram used to describe a first calculation method.

First, the formed aerial image MI is displayed in the mirror image space MS. At this time, a chart CIM divided into two parts of white and black is used as the display image. In this state, a region including the chart CIM of the formed aerial image MI is captured by a camera, and a captured image CMI is stored.

Next, the direct view aerial image RI is displayed in the mirror image space MS. At this time, as the display image, a chart CRI is used obtained by performing blur processing on an image to express a blur strength β and dividing the image into two parts of white and black. Then, a region including the chart CRI of the direct view aerial image is captured by the camera, and a captured image CRI is stored. Note that the blur processing indicates, for example, image processing using a Gaussian filter. In addition, B is a standard deviation.

Subsequently, structural similarity (SSIM) indicating an image quality evaluation index is calculated for each of the captured images CMI and CRI. Calculation processing for the SSIM is performed every time the blur strength β is changed by a certain amount, and β at which a difference in the SSIM between the captured images CMI and CRI is minimum is stored in the image parameter storage unit 302 as a parameter indicating the blur strength. Note that a mean squared error (MSE) or a peak signal to noise ratio (PSNR) may be used as the image quality evaluation index in addition to the SSIM.

### (2) Second Calculation Method

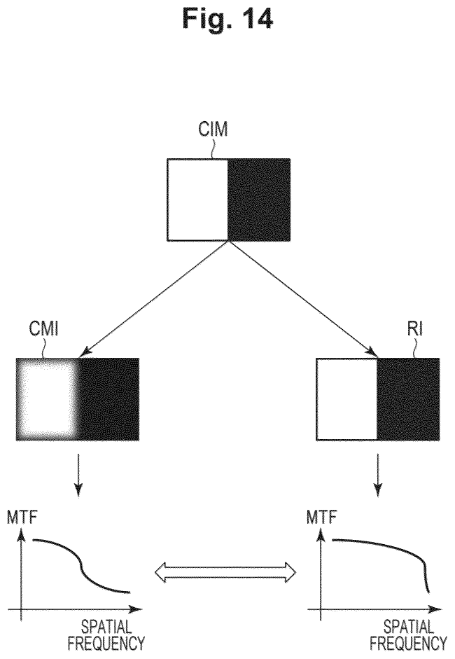

FIG. 14 is a diagram used to describe a second calculation method.

First, the formed aerial image MI is displayed in the mirror image space MS. As the display image, similarly to the first calculation method, the chart CIM divided into two parts of white and black is used. In this state, a region including the chart CIM of the formed aerial image MI is captured by the camera, and Fourier transform is performed on a captured image of the region to acquire and store a modulation transfer function (MSF).

Next, the direct view aerial image RI is displayed in the mirror image space MS. Also in this case, the chart CIM divided into two parts of white and black is used as the display image. Then, a region including the chart CRI of the direct view aerial image is captured by the camera, and Fourier transform is performed on a captured image of the region to acquire and store the MSF.

Subsequently, the MTF acquired in the formed aerial image MI and the MTF acquired in the direct view aerial image RI are normalized and then compared with each other, an attenuation rate B of a spatial frequency component is calculated, and the calculated B is stored in the image parameter storage unit 302 as a parameter indicating the blur strength.

When the aerial image is actually displayed, if the aerial image to be displayed is the “formed aerial image”, in step S13, the image parameter control processing unit 103 outputs the display information read from the display information storage unit 303 to the display device DS as it is from the input/output I/F unit 400 and displays the display information. That is, the display image is displayed as it is without adjustment of the image parameter.

On the other hand, in a case where the aerial image to be displayed is the “direct view aerial image”, in step S15, the image parameter control processing unit 103 adjusts the parameter on the basis of the control data of the image parameter, that is, control data for adjusting the blur strength β with respect to the display information read from the display information storage unit 303.

For example, the blur processing is performed on the display image with a Gaussian filter. Alternatively, the display image is subjected to Fourier transform and converted into a frequency space image, and then processing of attenuating the spatial frequency component is performed on the frequency space image. Then, inverse Fourier transform is performed on the frequency space image after the attenuation processing to restore the image to a two-dimensional display image.

Then, in step S13, the image parameter control processing unit 103 outputs the display image after the adjustment of the image parameter from the input/output I/F unit 400 to the display device DS and causes the display image to be displayed. That is, processing of forcibly adding a blur B is performed to display the display image with reduced contrast.

### (Effects)

Thus, according to the second embodiment, in the case of presenting the direct view aerial image, an image in which the blur B is added to the display image, that is, a display image in which the contrast is suppressed to be low in advance is displayed on the display device DS. As a result, the contrast of the direct view aerial image RI can be made equivalent to that of the formed aerial image MI, whereby the image quality is homogenized between the formed aerial image MI and the direct view aerial image RI. Thus, it is possible to suppress the user's discomfort with respect to image quality change of the aerial image when switching the display of the aerial image between the formed aerial image MI and the direct view aerial image RI seamlessly crossing the boundary between the mirror image space MS and the real space RS, whereby it is possible to display the aerial image with high reproducibility.

### (Modification)

In the above description, a case where contrast (blur strength) is controlled as the image parameter has been described as an example. However, luminance or color may be controlled as the image parameter. In this case, the luminance and color of the direct view aerial image RI can be made equivalent to those of the formed aerial image MI by adjusting RGB of the display image, whereby the image quality can be homogenized between the aerial images.

### Third Embodiment

### (Outline)

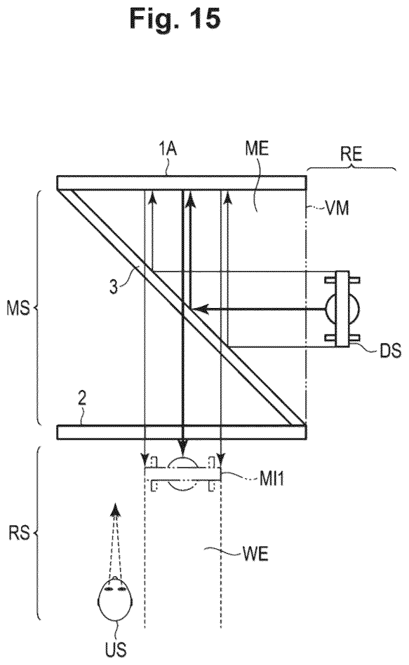

In general, there is a limit to a viewing area region, that is, a viewing angle, with respect to a display screen of the display device DS. For this reason, even in a case where an aerial image is displayed by the display device DS, the viewing area region of the user US with respect to the aerial image is naturally limited. As a result, for example, as illustrated in FIG. 15, there arises a problem that only an aerial image with reduced luminance can be visually recognized depending on a viewing position of the user US, or the viewing position of the user US deviates from the viewing area region of the aerial image and the aerial image cannot be visually recognized at all. This problem noticeably occurs in a case where, in particular, a viewing area limiting film is attached to the display screen of the display device DS to limit the viewing area in order to reduce the occurrence of stray light.

In a third embodiment of the present invention, in order to solve the above problem, a position of the user US in the real space RS is detected, and a display position and a display direction of the display device DS are variably controlled according to the detected position of the user US, whereby the user US can always view the aerial image from a front direction.

Hereinafter, as an example, a case will be described where both the display position and the display direction of the display device DS are variably controlled, but only at least the display direction may be variably controlled.

### (Configuration Example)

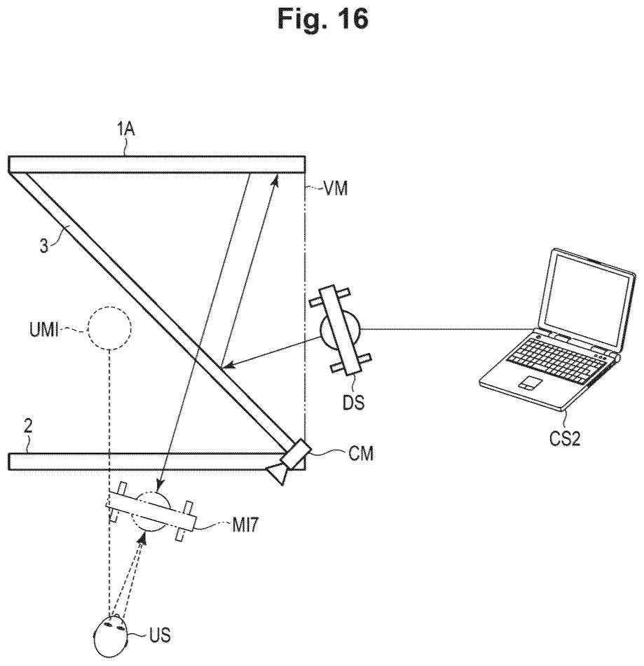

FIG. 16 is a diagram illustrating an example of a configuration of an aerial image display system according to the third embodiment of the present invention. Note that, in the figure, the same portions as those in FIG. 1 are denoted by the same reference signs, and detailed description thereof will be omitted.

The system according to the third embodiment includes a display control device CS2 for controlling the display position and the display direction of the display device DS. In addition, in order to enable control of the display position and the display direction, the display device DS is provided with the rotation mechanism unit 55 and the movement mechanism unit 56. Further, a camera CM is arranged in an optical system. The camera CM includes, for example, a depth camera, captures an image of a range where the user US is present in the real space RS, and outputs the captured image to the display control device CS2.

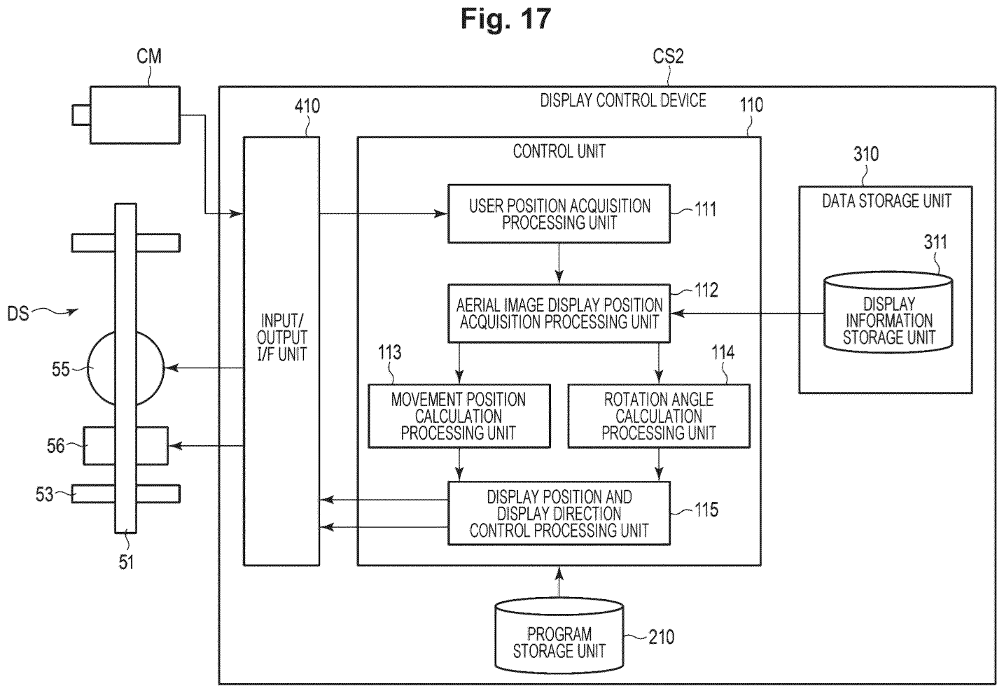

FIG. 17 is a block diagram illustrating a functional configuration of the display control device CS2 together with the display device DS and the camera CM.

Similarly to the second embodiment, the display control device CS2 includes, for example, a personal computer, and includes a control unit 110 using a hardware processor such as a CPU. In addition, a storage unit including a program storage unit 210 and a data storage unit 310, and an input/output I/F unit 410 are connected to the control unit 110 via a bus (not illustrated).

The display device DS and the camera CM are connected to the input/output I/F unit 410. More specifically, the display device main body 51 of the display device DS, the movement mechanism unit 56, the rotation mechanism unit 55, and the camera CM are connected via, for example, a signal cable or a wireless interface such as a wireless local area network (LAN).

The program storage unit 210 includes, as a storage medium, for example, a combination of a nonvolatile memory that enables writing and reading as needed, such as an SSD, and a nonvolatile memory such as a ROM, and stores an application program necessary for control processing according to the third embodiment, in addition to middleware such as an OS. Hereinafter, the OS and the application programs will be collectively referred to as programs.

The data storage unit 310 is, for example, a combination of a nonvolatile memory that enables writing and reading as needed, such as an SSD, and a volatile memory, such as a RAM, as a storage medium, and a display information storage unit 311 is provided in a storage area thereof. The display information storage unit 311 stores content information for displaying the aerial image for the user US. The content information is, for example, read from an external storage medium, or acquired by being downloaded from a server device on the Web or a cloud, or another information terminal, via a network.

The control unit 110 includes a user position acquisition processing unit 111, an aerial image display position acquisition processing unit 112, a movement position calculation processing unit 113, a rotation angle calculation processing unit 114, and a display position and direction control processing unit 115, as processing functions necessary for implementing the third embodiment of the present invention. The processing units 111 to 115 are implemented by causing a hardware processor of the control unit 110 to execute an application program stored in the program storage unit 210.

Note that some or all of the processing units 111 to 115 may be implemented by using hardware such as a large scale integration (LSI) or an application specific integrated circuit (ASIC).

The user position acquisition processing unit 111 acquires a captured image output from the camera CM via the input/output I/F unit 410, and calculates position information on the user US in the real space RS on the basis of the acquired captured image. Note that, in a case where the viewing position of the user is fixed, the user position acquisition processing unit 111 may acquire and store the fixed viewing position as a parameter in advance. In this case, the camera CM can be omitted.

The aerial image display position acquisition processing unit 112 acquires information representing the display position of the aerial image to be displayed from the content information stored in the display information storage unit 311.

The movement position calculation processing unit 113 calculates the display position of the display device DS on the basis of the position information on the user US and display position information on the aerial image.

The rotation angle calculation processing unit 114 calculates a rotation angle θ of the display device DS on the basis of the position information on the user US, the display position information on the aerial image, and information representing whether the aerial image to be displayed is the formed aerial image or the direct view aerial image. An example of calculation processing for rotation angle θ will be described in an operation example.

The display position and direction control processing unit 115 drives the movement mechanism unit 56 and the rotation mechanism unit 55 of the display device DS according to the calculated display position and rotation angle θ of the display device DS to control the display position and a display angle of the display device DS.

### (Operation Example)

Next, operation of the aerial image display system configured as described above will be described.

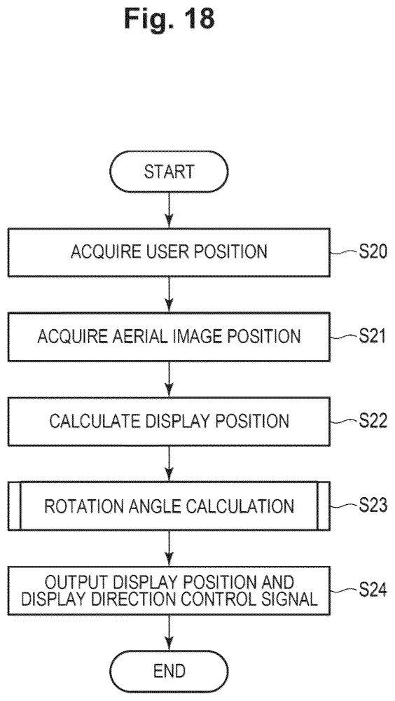

FIG. 18 is a flowchart illustrating an example of a processing procedure and processing content of display control processing executed by the control unit 110 of the display control device CS2.

### (1) Acquisition of User Position

When causing the aerial image to be displayed, the control unit 110 of the display control device CS2 first acquires user position information by the user position acquisition processing unit 111 in step S20. For example, the user position acquisition processing unit 111 acquires a captured image output from the camera CM via the input/output I/F unit 410, and recognizes an image of the user US from the acquired captured image. Then, the position information on the user US in the real space RS is calculated on the basis of position coordinates in the recognized image of the user US. Note that, as described above, in a case where the viewing position of the user is fixed, the user position acquisition processing unit 111 may acquire and store the fixed viewing position as a parameter in advance.

### (2) Acquisition of Aerial Image Display Position

Subsequently, in step S21, the control unit 110 of the display control device CS2 specifies the display position of the aerial image by the aerial image display position acquisition processing unit 112. For the aerial image display position, for example, in a case where the content information stored in the display information storage unit 311 includes information indicating a display target position of the aerial image, the display target position is acquired as it is as the display position information on the aerial image.

### (3) Calculation of Display Position of Display Device DS

When the position information on the user US and the display position information on the aerial image are obtained, next, in step S22, the control unit 110 of the display control device CS2 calculates the display position of the display device DS by the movement position calculation processing unit 113. The display position of the display device DS can be obtained as a position that is plane-symmetric with respect to the display position information on the aerial image.

### (4) Calculation of Display Angle of Display Device DS

In addition, next, in step S23, the control unit 110 of the display control device CS2 calculates the rotation angle θ for controlling the display direction of the display device DS by the rotation angle calculation processing unit 114 as follows.

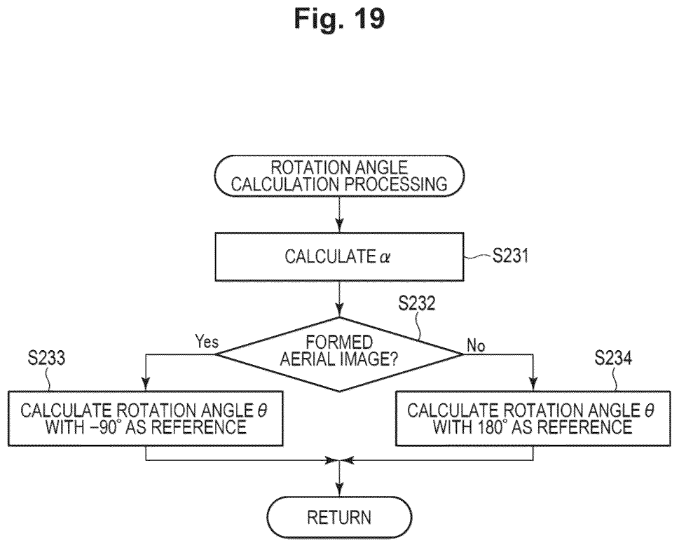

FIG. 19 is a flowchart illustrating an example of a processing procedure and processing content of the calculation processing for the rotation angle θ. That is, first, in step S231, the rotation angle calculation processing unit 114 calculates a direction of the user US with respect to the aerial image, that is, an angle α formed by a straight line connecting the user US to the aerial image, and a perpendicular line drawn from the user US to the first beam splitter 2, from information representing the display position of the aerial image and the position of the user US.

Subsequently, the rotation angle calculation processing unit 114 calculates the rotation angle θ. The calculation processing for the rotation angle θ varies depending on whether the aerial image is formed on the right side of the user US or formed on the left side of the user US.

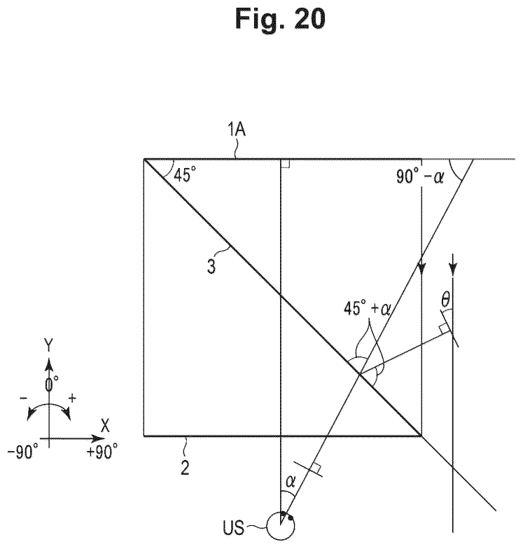

For example, in a case where the aerial image is formed on the right side of the user US, as illustrated in FIG. 20, the rotation angle calculation processing unit 114 first obtains (90−α)° from the angle α and a known angle 90°, and then obtains (45+α°) from the (90−α°) and a known angle 45°. Then, using the above (90−α)° and the known 90°,

$$180 ° = 90 ° + 90 - α° + θ$$

is calculated, whereby

$$θ = \vert α \vert$$

is calculated.

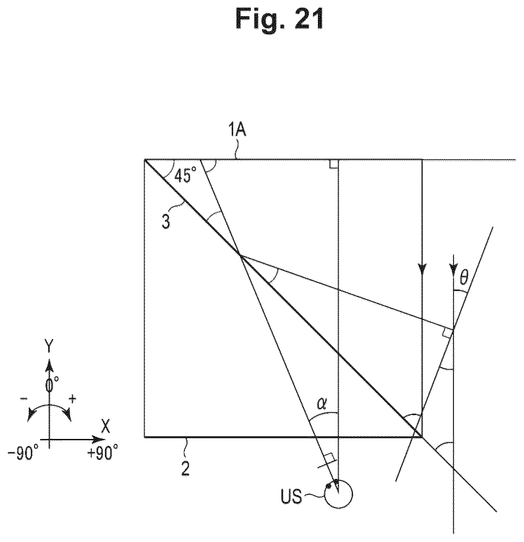

On the other hand, in a case where the aerial image is formed on the left side of the user US, for example, as illustrated in FIG. 21, the rotation angle calculation processing unit 114 calculates the rotation angle θ using the calculated angle α and the known angles 90° and 45°.

Further, in step S232, the rotation angle calculation processing unit 114 determines whether the aerial image to be displayed is the “formed aerial image” or the “direct view aerial image”. Then, in the case of the “formed aerial image”, in step S233, the final rotation angle θ is calculated with −90° as a reference. On the other hand, in the case of the “direct view aerial image”, in step S234, the final rotation angle θ is calculated with 180° as a reference.

### (5) Control of Movement Position and Display Direction of Display Device DS

When a movement position and the rotation angle θ are calculated as described above, the control unit 110 of the display control device CS2 generates control signals for changing the position and the angle by the calculated movement position and rotation angle θ in step S24 under control of the display position and direction control processing unit 115. Then, the display position and direction control processing unit 115 outputs the generated control signal for the movement position and control signal for the rotation angle from the input/output I/F unit 410 to the movement mechanism unit 56 and the rotation mechanism unit 55 of the display device DS, respectively.

In this way, the display position and the display direction of the display device DS are controlled, whereby an image forming position and the display direction of the aerial image are set to face the user US.

### (Effects)

As described above, according to the third embodiment, the display position and the display direction of the display device DS are controlled according to the position of the user US, whereby the image forming position and the direction of the aerial image are set to always face the user US. Therefore, the user US can always visually recognize the aerial image reliably and with high luminance at any position without adjusting the position of the user US correspondingly to the image forming position of the aerial image. This effect is particularly effective in a case where, for example, a viewing area limiting film is attached to the display screen of the display device DS to limit the viewing area in order to reduce the occurrence of stray light.

### (Modification)

In the above description, a case where the optical system includes the first beam splitter 2 has been described as an example, but the first beam splitter 2 does not necessarily have to be installed. Even in this case, an equivalent effect can be obtained.

### Fourth Embodiment

### (Outline)

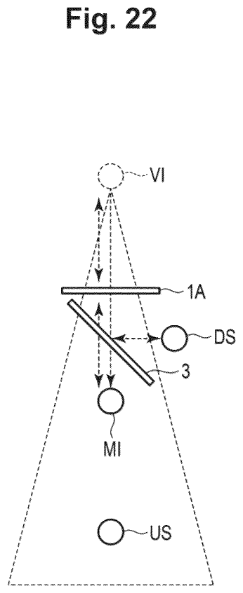

Normally, in an optical system using a retroreflective member, for example, as illustrated in FIG. 22, in a case where the user US faces the retroreflective member 1A, a virtual image VI of the display device DS is displayed as stray light behind the formed aerial image MI due to specular reflection of a surface of the retroreflective member 1A. Since the stray light is displayed brighter and clearer than the formed aerial image MI particularly in a case where a retroreflective component is weaker than a specular reflection component, the stray light causes a decrease in visibility of the formed aerial image MI by the user US.

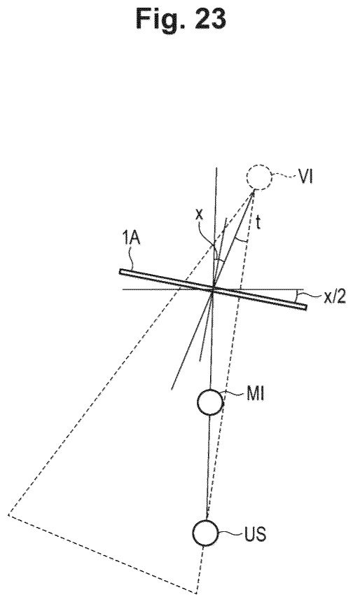

In order to solve the above problem, in a fourth embodiment of the present invention, for example, as illustrated in FIG. 23, a position of the user US is detected, and an angle of the reflective surface of the retroreflective member 1A is inclined by x/2 according to the detected position of the user US, to cause the retroreflective member 1A not to face the user US, whereby the virtual image VI of the display device DS deviates from the viewing direction of the user US with respect to the aerial image MI.

### (Configuration Example)

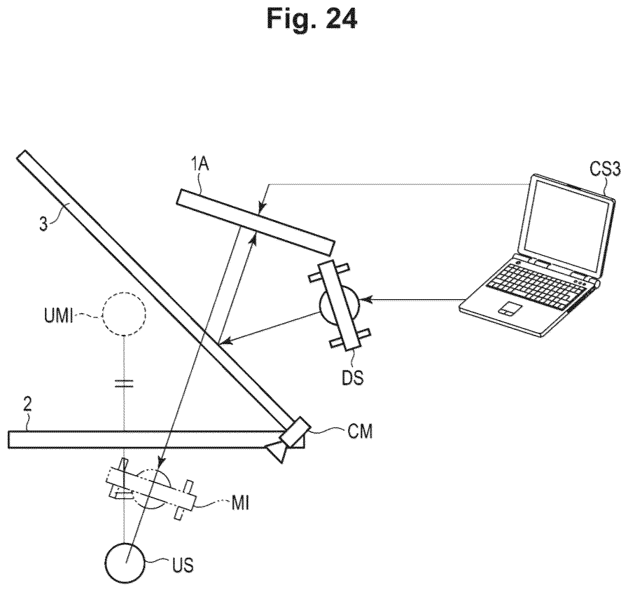

FIG. 24 is a diagram illustrating an example of a configuration of an aerial image display system according to the fourth embodiment of the present invention.

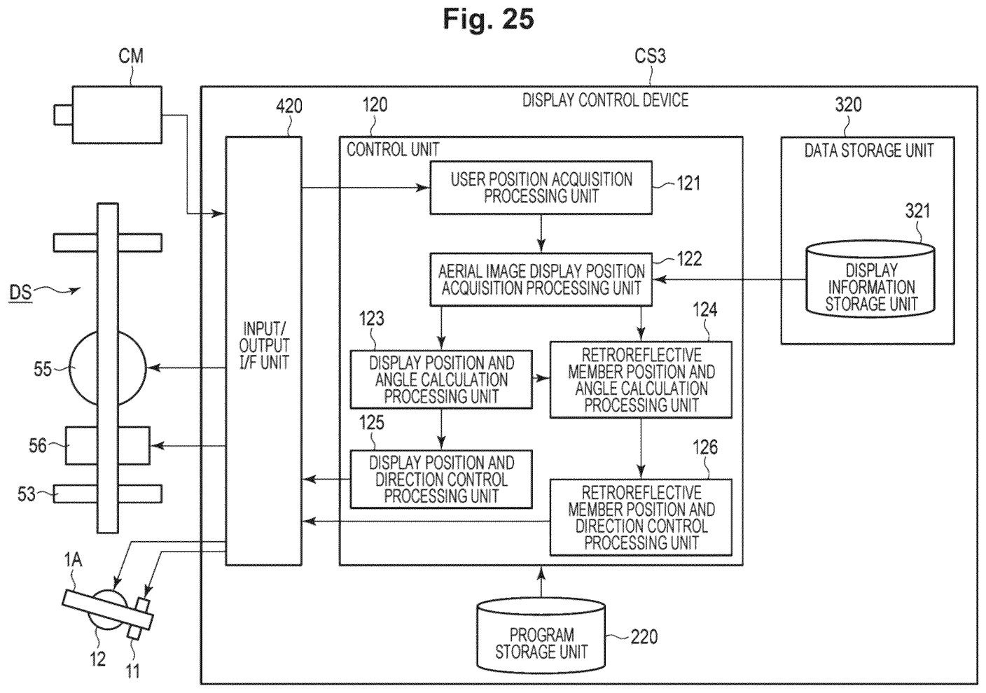

In the system according to the fourth embodiment, the display device DS is provided with the rotation mechanism unit 55 and the movement mechanism unit 56, and the retroreflective member 1A is provided with a movement mechanism unit 11 and a rotation mechanism unit 12 (illustrated in FIG. 25) for causing the position and the direction thereof to be variable.

Further, a display control device CS3 is included to control the display position and the display direction of the display device DS, and an arrangement position and a reflection direction of the retroreflective member 1A.

In addition, the camera CM is arranged in the optical system. The camera CM includes, for example, a depth camera, captures an image of a range where the user US is present in the real space RS, and outputs the captured image to the display control device CS3. Note that, in a case where the viewing position of the user is fixed, the camera CM can be omitted.

FIG. 25 is a block diagram illustrating a functional configuration of the display control device CS3 together with the display device DS, the retroreflective member 1A, and the camera CM.

The display control device CS3 includes, for example, a personal computer, and includes a control unit 120 using a hardware processor such as a CPU. In addition, a storage unit including a program storage unit 220 and a data storage unit 320, and an input/output I/F unit 420 are connected to the control unit 120 via a bus (not illustrated).

Mechanism units of the display device DS and the retroreflective member 1A, and the camera CM are connected to the input/output I/F unit 420. More specifically, for example, via a signal cable or a wireless interface such as a wireless local area network (LAN), the display device main body 51, the movement mechanism unit 56, and the rotation mechanism unit 55 of the display device DS are connected, and the mechanism of the retroreflective member 1A is connected, and further, the camera CM is connected.

The program storage unit 220 includes, as a storage medium, for example, a combination of a nonvolatile memory that enables writing and reading as needed, such as an SSD, and a nonvolatile memory such as a ROM, and stores an application program necessary for control according to the fourth embodiment, in addition to middleware such as an OS. Hereinafter, the OS and the application programs will be collectively referred to as programs.

The data storage unit 320 is, for example, a combination of a nonvolatile memory that enables writing and reading as needed, such as an SSD, and a volatile memory, such as a RAM, as a storage medium, and a display information storage unit 321 is provided in a storage area thereof.

The display information storage unit 321 stores content information for displaying the aerial image for the user US. The content information is, for example, read from an external storage medium, or acquired by being downloaded from a server device on the Web or a cloud, or another information terminal, via a network.

The control unit 120 includes a user position acquisition processing unit 121, an aerial image display position acquisition processing unit 122, a display position and angle calculation processing unit 123, a retroreflective member position and angle calculation processing unit 124, a display position and direction control processing unit 125, and a retroreflective member position and direction control processing unit 126, as processing functions necessary for implementing the fourth embodiment. The processing units 121 to 126 are implemented by causing a hardware processor of the control unit 120 to execute an application program stored in the program storage unit 220.

Note that some or all of the processing units 121 to 126 may be implemented by using hardware such as an LSI or an ASIC.

The user position acquisition processing unit 121 acquires a captured image output from the camera CM via the input/output I/F unit 420, and calculates position information on the user US in the real space RS on the basis of the acquired captured image. Note that, in a case where the viewing position of the user is fixed, the user position acquisition processing unit 121 may acquire and store the viewing position as a parameter. In this case, the camera CM can be omitted.

The aerial image display position acquisition processing unit 122 acquires information representing the display position of the aerial image to be displayed from the content information stored in the display information storage unit 321.

The display position and angle calculation processing unit 123 calculates display position of the display device DS on the basis of the position information on the user US and the display position information on the aerial image. In addition, the display position and angle calculation processing unit 123 calculates a rotation angle θ of the display device DS on the basis of the position information on the user US, the display position information on the aerial image, and information representing whether the aerial image to be displayed is the formed aerial image or the direct view aerial image.

The retroreflective member position and angle calculation processing unit 124 calculates a position of the retroreflective member 1A so that the optical path length from the user US is the shortest on the basis of the position information on the user US obtained by the user position acquisition processing unit 121 and further in consideration of the display position of the display device DS and a known arrangement position of the first beam splitter 2.

In addition, the retroreflective member position and angle calculation processing unit 124 calculates a rotation angle x/2 of the reflective surface of the retroreflective member 1A for causing the reflective surface of the retroreflective member 1A to face the user US on the basis of the position information on the user US obtained by the user position acquisition processing unit 121, the display position of the display device DS, and a viewing area (viewing angle) of the display device DS defined by a standard.

Note that an example of calculation processing for the position of the retroreflective member 1A and calculation processing for the rotation angle will be described in an operation example.

The display position and direction control processing unit 125 drives the movement mechanism unit 56 and the rotation mechanism unit 55 of the display device DS according to the calculated display position and rotation angle θ of the display device DS to control the display position and the display angle of the display device DS.

The retroreflective member position and direction control processing unit 126 drives the movement mechanism unit 11 and the rotation mechanism unit 12 of the retroreflective member 1A according to the position and the rotation angle x/2 of the retroreflective member 1A calculated by the retroreflective member position and angle calculation processing unit 124 to control the position and the reflection direction of the retroreflective member 1A.

### (Operation Example)

Next, operation of the aerial image display system configured as described above will be described.

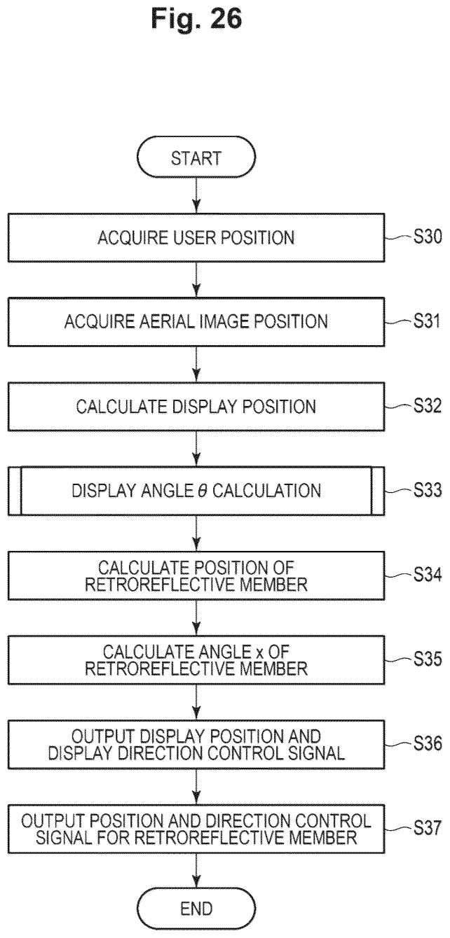

FIG. 26 is a flowchart illustrating an example of a processing procedure and processing content of display control processing executed by the control unit 120 of the display control device CS3.

### (1) Acquisition of User Position

When causing the aerial image to be displayed, the control unit 120 of the display control device CS3 first acquires user position information by the user position acquisition processing unit 121 in step S30. For example, the user position acquisition processing unit 121 acquires a captured image output from the camera CM via the input/output I/F unit 420, and recognizes an image of the user US from the acquired captured image. Then, the position information on the user US in the real space RS is calculated on the basis of position coordinates in the recognized image of the user US. Note that, as described above, in a case where the viewing position of the user is fixed, the user position acquisition processing unit 121 may acquire and store the fixed viewing position as a parameter in advance.

### (2) Acquisition of Aerial Image Display Position

Subsequently, in step S31, the control unit 120 of the display control device CS3 specifies the display position of the aerial image by the aerial image display position acquisition processing unit 122. For the aerial image display position, for example, in a case where the content information stored in the display information storage unit 321 includes information indicating a display target position of the aerial image, the display target position is acquired as it is as the display position information on the aerial image.

### (3) Calculation of Display Position and Display Angle of Display Device DS

### (3-1) Calculation of Display Position

When the position information on the user US and the display position information on the aerial image are obtained, next, in step S32, the control unit 120 of the display control device CS3 calculates the display position of the display device DS by the display position and angle calculation processing unit 123. The display position of the display device DS can be obtained as a position that is plane-symmetric with respect to the display position information on the aerial image.

### (3-2) Calculation of Rotation Angle θ for Setting Display Direction

In addition, next, in step S33, the display position and angle calculation processing unit 123 calculates the rotation angle θ for setting the display direction of the display device DS as follows. Note that calculation processing for the rotation angle θ is the same as the processing described in FIG. 19, and thus the description thereof will be omitted here.

### (4) Calculation of Position of Retroreflective Member 1A and Angle x/2 of Reflective Surface

Next, under control of the retroreflective member position and angle calculation processing unit 124, the control unit 120 of the display control device CS3 calculates the position of the retroreflective member 1A and the angle x/2 of the reflective surface in steps S34 and S35, respectively.

### (4-1) Calculation of Movement Position of Retroreflective Member 1A

In the case of presenting the formed aerial image MI to the user US, in order to present the formed aerial image MI with high image quality, it is desirable to minimize the optical path length in which the light of the display image output from the display device DS is perceived by the user US.

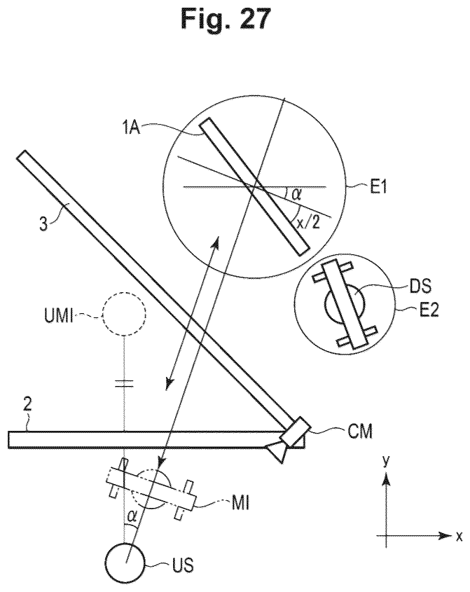

Thus, the retroreflective member position and angle calculation processing unit 124 calculates the movement position of the retroreflective member 1A so that the following conditions are satisfied. FIG. 27 is a diagram for describing calculation processing for the movement position.

It is defined that the retroreflective member position and angle calculation processing unit 124 first moves the retroreflective member 1A on a straight line connecting the user US to an image forming position of the aerial image. In addition, safety areas E1 and E2 for preventing collision are set for the retroreflective member 1A and the display device DS, respectively.

For example, as the safety area E1 of the retroreflective member 1A, a circle is defined including the maximum width of the reflective surface of the retroreflective member 1A. On the other hand, as the safety area E2 of the display device DS, a circle is defined including a portion in which the width length is the maximum among the display device main body 51 or the base 52 supporting the display device main body, and the leg portion 53.

In this state, the retroreflective member position and angle calculation processing unit 124 calculates an optimum position of the retroreflective member 1A. For example, the retroreflective member position and angle calculation processing unit 124 first obtains a position where the safety area E1 of the retroreflective member 1A maintains a safe distance from the safety area E2 of the display device DS and the second beam splitter 3. Then, a position is obtained where a coordinate value in the y direction of the circle indicating the safety area E1 of the retroreflective member 1A is minimized, and a position is calculated where the retroreflective member 1A is closest to the user US within a range in which the position is smaller than a position where a coordinate value in the y direction of the circle indicating the safety area E2 of the display device DS is maximized. Then, the calculated position is set as a position where the retroreflective member 1A should be moved.

### (4-2) Calculation of Reflection Angle of Retroreflective Member 1A

Next, the retroreflective member position and angle calculation processing unit 124 calculates the rotation angle x/2 for further rotating the retroreflective member 1A in addition to the angle α calculated by the display position and angle calculation processing unit 123, that is, the angle α formed by a direction in which the user US faces the first beam splitter 2 and a straight line connecting the user US to the aerial image MI.

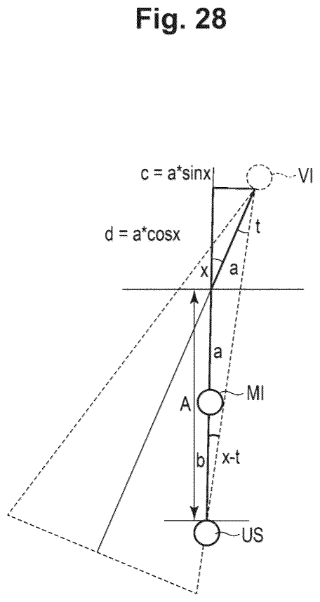

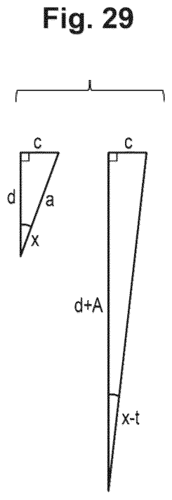

FIGS. 28 and 29 are diagrams used for calculation processing for the rotation angle x/2. Here, the following values are known parameters.
a: Distance from display position of display device DS to retroreflective member 1A
b: Distance from display device DS to viewpoint of user US
t: Viewing area of display device DS.

Note that the distance b from the display device DS to the viewpoint of the user US is calculated on the basis of the position information on the user US obtained by the user position acquisition processing unit 121. In addition, the viewing area t of the display device DS is represented by a rating of a viewing area limiting film in a case where the viewing area limiting film is attached to the display screen, for example.

First, the retroreflective member position and angle calculation processing unit 124 calculates a distance A from a viewpoint position of the user US to the retroreflective member 1A, and B as follows. Note that B is a symbol defined only in the formula as B=tan(t) for convenience.

$$[ Math . 1 ]$$

$$A = a + b \qquad ( 1 )$$

$$tan ( x - t ) = \frac{tan x - tan t}{1 + tan x - tan t}$$

$$∵ tan x = \frac{c}{d}$$

$$tan ( x - t ) = \frac{\frac{c}{d} - tan t}{1 + \frac{c}{d} - tan t}$$

$$∵ tan x = \frac{c}{A + d}$$

$$\frac{c}{A + d} = \frac{\frac{c}{d} - tan t}{1 + \frac{c}{d} - tan t}$$

$$B = tan t$$

$$( 1 ) =$$

$$( A + d ) ( \frac{c}{d} - B ) = c ( 1 + \frac{Bc}{d} )$$

$$\frac{Ac}{d} - AB + c - Bd = c + \frac{{Bc}^{2}}{d}$$

$$Ac - ABd + cd - {Bc}^{2} = cd + {Bc}^{2}$$

$$Ac - ABd = {Bc}^{2} + {Bd}^{2}$$

$$A ( c - Bd ) = B ( {c}^{2} + {d}^{2} )$$

$$∵ {c}^{2} + {d}^{2} = {a}^{2}$$

$$A ( c - Bd ) = {a}^{2} B$$

$$c - Bd = \frac{{a}^{2} B}{A}$$

$$a sin x - aB cos t = \frac{{a}^{2} B}{A}$$

$$sin x - B cos t = \frac{aB}{A}$$

$$sin x - B cos t = \sqrt{( 1 + {B}^{2} )} sin ( x + γ )$$

$$where$$

$$cos γ = \frac{1}{\sqrt{( 1 + {B}^{2} )}} ,$$

$$sin γ = \frac{- B}{\sqrt{( 1 + {B}^{2} )}}$$

Subsequently, the retroreflective member position and angle calculation processing unit 124 calculates the angle x as follows using the calculated A and B.

$$[ Math . 2 ]$$

$$\sqrt{( 1 + {B}^{2} )} sin ( x + γ ) = \frac{aB}{A}$$

$$sin ( x + γ ) = \frac{aB}{A \sqrt{( 1 + {B}^{2} )}}$$

$$x + γ = arcsin \frac{aB}{A \sqrt{( 1 + {B}^{2} )}}$$

$$∴ x = arcsin \frac{aB}{A \sqrt{( 1 + {B}^{2} )}} - γ$$

$$\frac{B}{\sqrt{( 1 + {B}^{2} )}} = \frac{tan t}{\sqrt{1 + {tan}^{2} t}}$$

$$= \frac{\frac{sin t}{cos t}}{\sqrt{1 + \frac{{sin}^{2} t}{{cos}^{2} t}}}$$

$$= \frac{\frac{sin t}{cos t} cos t}{\sqrt{{cos}^{2} t + {sin}^{2} t}}$$

$$= sin t$$

$$sin γ = \frac{- B}{\sqrt{1 + {B}^{2}}}$$

$$= - sin t$$

$$∴ γ = t \pm π$$

$$x = arcsin ( \frac{aB}{A \sqrt{( 1 + {B}^{2} )}} ) - γ$$

$$= arcsin ( \frac{a sin t}{A} ) - t ∓ x$$

$$= arcsin ( \frac{a sin t}{a + b} ) - t ∓ x$$

In this way, the rotation angle α+x/2 of the reflective surface of the retroreflective member 1A is calculated.

### (5) Control of Movement Position and Display Direction of Display Device DS

Under control of the display position and direction control processing unit 115, in step S36, the control unit 120 of the display control device CS3 generates a control signal for adjusting the position and angle of the display device DS by the calculated movement position and rotation angle θ of the display device DS. Then, the display position and direction control processing unit 125 outputs the generated control signal for the movement position and control signal for the rotation angle from the input/output I/F unit 420 to the movement mechanism unit 56 and the rotation mechanism unit 55 of the display device DS, respectively. In this way, the display position and the display direction of the display device DS are controlled.

### (6) Control of Position and Reflection Direction of Retroreflective Member 1A

In addition, under control of the retroreflective member position and direction control processing unit 126, in step S37, the control unit 120 of the display control device CS3 generates control signals for adjusting the position and angle of the retroreflective member 1A by the calculated movement position and rotation angle α+x/2 of the retroreflective member 1A. Then, the retroreflective member position and direction control processing unit 126 outputs the generated position control signal and rotation angle control signal from the input/output I/F unit 420 to the movement mechanism unit 11 and the rotation mechanism unit 12 of the retroreflective member 1A, respectively. In this way, the position and the reflection direction of the retroreflective member 1A are controlled.

### (Effects)

As described above, according to the fourth embodiment, the display position and the display angle of the display device DS are controlled according to the position of the user US and the display position of the aerial image, and the position and the reflection direction of the retroreflective member 1A are controlled according to the display position of the display device DS and the position of the user US, whereby the retroreflective member 1A is set not to face the user US.

As a result, it is possible to prevent the virtual image VI of the display device DS from entering the viewing area of the user US who is visually recognizing the aerial image MI, whereby visibility of the aerial image MI by the user US can be improved.

### (Modification)

Note that, in the above description, the position and angle of the reflective surface of the retroreflective member 1A are controlled, but only the angle of the reflective surface may be controlled. In addition, the position and the display direction of the display device DS are also controlled, but the position and the display direction of the display device DS do not have to be controlled.

### Fifth Embodiment

### (Outline)

Performance of displaying a background image behind an aerial image in order to reinforce a sense of reality of the aerial image is extremely effective in practical use. For example, when an aerial image of a character, an object, or the like and an image representing a shadow thereof are displayed in conjunction with each other, a more realistic display is possible.

However, even if a background image is to be displayed, a space for installing a display device for a background may not be secured in the real space in which the first beam splitter on the user side is arranged. In addition, when the display device for aerial image display is moved to the mirror image space movement region as illustrated in FIG. 4, for example, in order to display the aerial image in the mirror image space, a background image is shielded by the moved device. As a result, a portion other than a portion corresponding to the display device in the background image is perceived as black, and display of the aerial image is inhibited.

Thus, in a fifth embodiment of the present invention, a second display device for background display is arranged in a space on an opposite side from an arrangement position of a first display device for displaying an aerial image with a second beam splitter interposed therebetween, and a background image displayed on the second display device is reflected by the second beam splitter and displayed in a user US direction.

### First Example

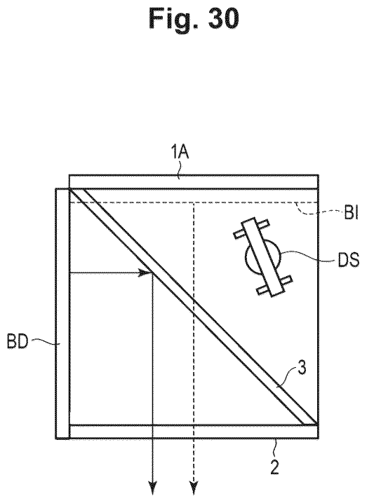

FIG. 30 is a diagram illustrating a first example of an optical system of an aerial image display system according to the fifth embodiment of the present invention. Note that, in the figure, the same portions as those in FIG. 1 are denoted by the same reference signs, and detailed description thereof will be omitted.

In FIG. 30, a display device BD for background display is arranged in a space on an opposite side from an arrangement position of the display device DS for displaying an aerial image with the second beam splitter 3 interposed therebetween. A background image displayed on the display device BD for background display is reflected by the second beam splitter 3 and then transmitted through the first beam splitter 2 to be presented to the user US present in the real space RS.

With such a configuration, the display device BD for background display can be installed even in a case where an installation space cannot be secured in the real space RS where the user US is present. In addition, as illustrated in FIG. 30, even in a case where the display device DS for aerial image display is moved into the mirror image space movement region ME in order to form the aerial image MI in the mirror image space MS, the display device DS does not interfere with a virtual image BI of the background image.

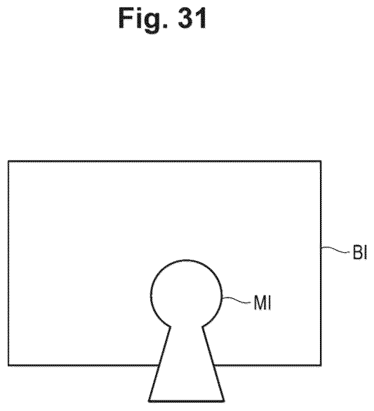

As a result, an aerial image with a background in which only the formed aerial image MI is superimposed on the background image BI is presented to the user US. FIG. 31 illustrates an example of a display image of the presentation. Thus, after solving the problem of an arrangement space of the display device BD for background display, and it is further possible to present a clear aerial image with a background to the user US without inhibiting display of the aerial image MI displayed by the display device DS.

Note that, in order to resolve occlusion contradiction between the background image BI and the aerial image MI, display of a background range overlapping the aerial image MI may be erased on the basis of the position of the user US.

### Second Example

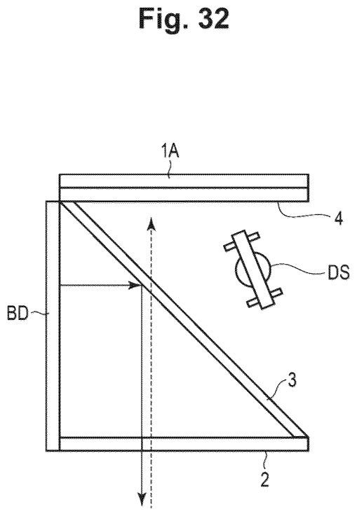

FIG. 32 is a diagram illustrating a second example of the optical system of the aerial image display system according to the fifth embodiment of the present invention. Note that, in the figure, the same portions as those in FIG. 30 are denoted by the same reference signs.

In the second example, as the second beam splitter 3, an optical element is used such as a reflective polarizing plate whose transmission and reflection change depending on a polarization direction. The retardation film 4 is arranged on the reflective surface side of the retroreflective member 1A. Note that, as the first beam splitter 2, a semitransparent mirror is used in which a reflection characteristic does not change depending on the polarization direction, for example, a transparent plate is subjected to metal vapor deposition.

With such a configuration, by matching a polarization characteristic of the second beam splitter 3 with a polarization direction of a display image output from the display device DS, it is possible to suppress attenuation of a luminance level of the aerial image, whereby it is possible to present a high luminance and clear aerial image with a background.

### Third Example

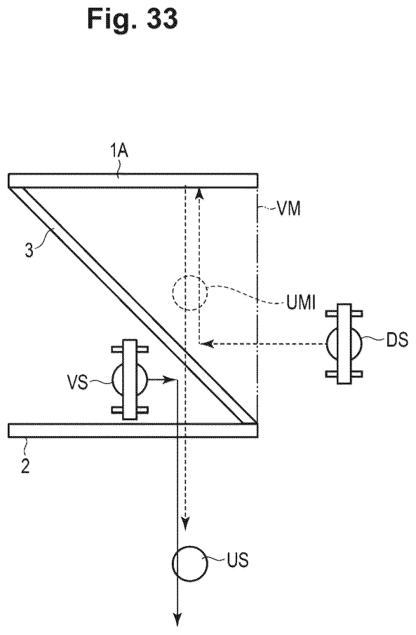

FIG. 33 is a diagram illustrating a third example of the optical system of the aerial image display system according to the fifth embodiment of the present invention. Note that, in the figure, the same portions as those in FIG. 30 are denoted by the same reference signs.

In the third example, a display device VS for virtual image display is used instead of the display device BD for background display. Similarly to the display device DS for aerial image display, the display device VS for virtual image display includes a movement mechanism unit and a rotation mechanism unit for causing the display position and the display direction to be variable, whereby movement is enabled in the mirror image space MS on an opposite side from the arrangement position of the display device DS with the second beam splitter 3 interposed therebetween.

With such a configuration, for example, it is assumed that a front image of a character or an article is displayed by the display device DS for aerial image display, and in synchronization with that, a back image of the character or the article is displayed by the display device VS for virtual image display. Then, an aerial image corresponding to a virtual image of a formed aerial image corresponding to the front image of the character or the article and an aerial image corresponding to the back image of the character or the article are simultaneously presented to the user US present in the real space RS.

Thus, it is possible to perform display by using virtual image representation as if the aerial image displayed in the real space were reflected in the mirror.

### Other Embodiments

In addition, the materials, functions, and arrangement relationship of the retroreflective members and the first and second beam splitters constituting the optical system, the type and configuration of the display device, the type of content for displaying the aerial image, and the like can be variously modified without departing from the gist of the present invention. In addition, the functional configurations of the display control devices CS1, CS2, and CS3 and the procedures and processing contents of the control processing thereof can also be variously modified without departing from the gist of the present invention.

Although the embodiments of the present invention have been described in detail, the description provided above is merely an example of the present invention in all respects. It is needless to say that various improvements and modifications can be made without departing from the scope of the present invention. That is, in carrying out the present invention, specific configurations according to the embodiments may be appropriately adopted.

In short, the present invention is not limited to the embodiments without any change and can be embodied by modifying the components without departing from the gist of the present invention at the implementation stage. Further, various inventions can be made by appropriately combining the plurality of components disclosed in the embodiments. For example, some components may be deleted from all the components described in the embodiments. Further, the components in different embodiments may be combined as appropriate.

### REFERENCE SIGNS LIST

US Viewer (user)
DS Display device for aerial image display
RS Real space
MS Mirror image space
RE Real space movement region
ME Mirror image space movement region
RI Direct view aerial image
MI Formed aerial image
BD Display device for background display
1A, 1B Retroreflective member
2 First beam splitter
3 Second beam splitter
4 Retardation film
11, 56 Movement mechanism unit
12, 55 Rotation mechanism unit
51 Display device main body
52 Base
53 Leg portion
54 Caster
100, 110, 120 Control unit
101 Display instruction acquisition processing unit
102 Display position and direction control processing unit
103 Image parameter control processing unit
111, 121 User position acquisition processing unit
112, 122 Aerial image display position acquisition processing unit
113 Movement position calculation processing unit
114 Rotation angle calculation processing unit
115 Display position and direction control processing unit
123 Display position and angle calculation processing unit
124 Retroreflective member position and angle calculation processing unit
125 Display position and direction control processing unit
126 Retroreflective member position and direction control processing unit
200, 210, 220 Program storage unit
300, 310, 320 Data storage unit
301 Display position and direction control data storage unit
302 Image parameter storage unit
303 Display information storage unit.
311, 321 Display information storage unit
400, 410, 420 Input/output I/F unit
500 Input device.

1. An aerial image display system including: a display device that displays a display image; and an optical system that includes a retroreflective member and an optical member having an optical characteristic of reflecting part of incident light and transmitting part of the incident light, and displays an aerial image corresponding to the display image toward a viewer, the aerial image display system comprising:
a position information acquisition unit that acquires position information on the viewer; and
a display control unit that rotates an angle of a reflective surface of the retroreflective member by a designated angle from a direction of the viewer as a reference on a basis of the position information on the viewer acquired.

2. A display control device used in an aerial image display system that displays an aerial image corresponding to a display image toward a viewer by causing the display image displayed on a display device to be transmitted through an optical system in which a retroreflective member and an optical member that has an optical characteristic of reflecting part of incident light and transmitting part of the incident light are combined, the display control device comprising:
a first position information acquisition unit that acquires position information on the viewer; and
a display control unit that rotates an angle of a reflective surface of the retroreflective member by a designated angle from a direction of the viewer as a reference on a basis of the position information on the viewer acquired.

3. The display control device according to claim 2, further comprising a second position information acquisition unit that acquires position information on the display device, wherein
the display control unit controls a position of the retroreflective member with respect to the viewer and an angle of the reflective surface on a basis of the position information on the viewer and the position information on the display device.

4. The display control device according to claim 3, wherein the display control unit sets the position of the retroreflective member to a position where a non-contact state with the display device is maintained and a distance from the viewer is shortest on a straight line connecting the viewer to a display position of the aerial image.

5. The display control device according to claim 3, wherein the display control unit calculates the angle of the reflective surface of the retroreflective member on a basis of a distance from the position of the display device to the retroreflective member, a distance from the position of the display device to the position of the viewer, and a viewing area of the display device.

6. A display control method executed by a control device used in an aerial image display system that displays an aerial image corresponding to a display image toward a viewer by causing the display image displayed on a display device to be transmitted through an optical system in which a retroreflective member and an optical member that has an optical characteristic of reflecting part of incident light and transmitting part of the incident light are combined, the display control method comprising:
acquiring position information on the viewer; and
rotating an angle of a reflective surface of the retroreflective member by a designated angle from a direction of the viewer as a reference on a basis of the position information on the viewer acquired.

7. The display control method according to claim 6, further comprising:
acquiring position information on the display device; and
controlling a position of the retroreflective member with respect to the viewer on a basis of the position information on the viewer and the position information on the display device.

8. A non-transitory computer-readable storage medium configured with instructions executable by one or more processors included in a display control device to cause the one or more processors to perform operations comprising:
acquiring position information on a viewer, the display control device being used in an aerial image display system that displays an aerial image corresponding to a display image toward a viewer by causing the display image displayed on a display device to be transmitted through an optical system in which a retroreflective member and an optical member that has an optical characteristic of reflecting part of incident light and transmitting part of the incident light are combined; and
rotating an angle of a reflective surface of the retroreflective member by a designated angle from a direction of the viewer as a reference on a basis of the position information on the viewer acquired.

9. The non-transitory computer-readable storage medium according to claim 8, wherein the operations further comprise acquiring position information on the display device, wherein
the rotating the angle of the reflective surface controls a position of the retroreflective member with respect to the viewer and an angle of the reflective surface on a basis of the position information on the viewer and the position information on the display device.

10. The non-transitory computer-readable storage medium according to claim 9, wherein the rotating the angle of the reflective surface sets the position of the retroreflective member to a position where a non-contact state with the display device is maintained and a distance from the viewer is shortest on a straight line connecting the viewer to a display position of the aerial image.

11. The non-transitory computer-readable storage medium according to claim 9, wherein the rotating the angle of the reflective surface calculates the angle of the reflective surface of the retroreflective member on a basis of a distance from the position of the display device to the retroreflective member, a distance from the position of the display device to the position of the viewer, and a viewing area of the display device.
